(19) United States
(12) Patent Application Publication
(10) Pub. No.: US 2026/0211170 A1
(43) Pub. Date: Jul. 23, 2026

(54) FLEXIBLE AND TRANSPARENT LIGHT GUIDE FOR A LIGHT DEVICE

(71) Applicant: VALEO VISION, Bobigny (FR)

(72) Inventors: Rabih TALEB, Bobigny (FR); Pierre-Louis TASSY, Bobigny (FR); Shivi SINGH, Bobigny (FR); Hafid EL-IDRISSI, Bobigny (FR); Ghani SBIHI, Bobigny (FR)

(73) Assignee: VALEO VISION, Bobigny (FR)

(21) Appl. No.: 19/142,438

(22) PCT Filed: Dec. 19, 2023
(86) PCT No.: PCT/EP2023/086766

§ 371 Date: Jun. 23, 2025

(30) Foreign Application Priority Data
Dec. 23, 2022 (FR) 2214469

(51) Int. Cl. F21V 8/00; F21S 41/24

(52) U.S. Cl. CPC G02B 6/0028; F21S 41/24; G02B 6/0068

(57) ABSTRACT

The invention relates to a flexible and transparent light guide. The light guide includes a flexible and transparent light-guide layer suitable for guiding light by total internal reflection and for allowing light to exit through an exit face in a first direction, at least two groups of light-injection elements suitable for coupling a light-guide layer to at least one light source, and a support element for folding the light-injection elements including at least two series of folding elements, each series being associated with a different group of light-injection elements, and the at least two series of folding elements being offset in the first direction so that the at least two groups of light-injection elements are offset in the first direction.

### TECHNICAL FIELD

The technical field of the invention is that of flexible luminous devices and particularly that of flexible luminous devices for automobiles.

One subject of the invention relates to a light guide for a luminous device. Another subject of the invention relates to a luminous device comprising a light guide according to the invention.

### BACKGROUND OF THE INVENTION

One example of a luminous device comprising a flexible transparent film suitable for guiding light is described in application WO 2011/130715 A2.

A luminous device 100 according to the prior art is illustrated in FIG. 1a to 1e. The luminous device 100 comprises a light guide 105 and a plurality of light sources 104. The light guide 105 comprises a flexible and transparent light guide sheet 110, referred to hereinafter as guide sheet, capable of receiving light rays through a light injection edge 114 and of returning the light rays in a direction x substantially normal to a surface of the guide sheet which thus extends in a plane y-z in FIG. 1a. The directions x, y and z are defined in relation to the frame of reference illustrated in FIG. 1a.

What is meant by guide sheet 110 is an optical guide element for the light rays, one of the dimensions of which is much smaller than the other two dimensions in space. In this case it is a guide sheet of which the thickness along the axis x is at least two orders of magnitude smaller than its dimensions in the plane y-z in which the guide sheet 110 extends. For example, the guide sheet has a thickness along the axis x that is comprised between 200 and 1000 micrometers and extends over several cm in the directions y and z.

The guide sheet 110 may comprise at its core a flexible film 111 comprising the light injection edge 114. The flexible film further comprises a collection of light extraction elements 113 able to return the light rays guided in the flexible film 111 to outside the flexible guide sheet 110, notably in one or more directions substantially along the axis x. By way of example, the light extraction elements 113 may be microstructures 113 etched into the flexible film 111. In the remainder of the description, the microstructures 113 are cited by way of an example of the light extraction elements 113.

In one exemplary embodiment, the light rays re-emerge in the direction +x according to the orientation illustrated in FIG. 1a. For example, the light rays are emitted to outside the front face of a vehicle.

The flexible guide sheet 110 may further comprise one or two optional protective layers 112.1 and 112.2, which make it possible to mechanically protect the flexible film 111.

The light rays travel through the flexible film 111 by total internal reflection thanks to the difference between the refractive index of the flexible film 111 and that of a layer of glue or adhesive applied to at least one face of the flexible film.

The guide sheet 110, or more specifically the flexible film 111, may comprise a mixing zone 111.2 and several light-emission zones 111.1 provided. When there are multiple groups 102 of light-injection elements, each group 102 is configured to illuminate a different region in the light guide sheet 110. What is meant by illuminate is an act of transmitting or injecting light into a defined region.

The mixing zone 111.2 is positioned upstream of the light-emission zone in the direction of travel of the light rays within the light guide sheet 110. The light injected into the light guide sheet 110 via the edge 114 will be mixed in the light-mixing region 111.2 in order to obtain more uniform luminous intensity. The light then travels into the light-emission zones 111.1 via which the light re-emerges from the light guide sheet 110 in the direction x.

The light guide 105 according to the prior art further comprises at least one group 102 of light-injection elements.

A group 102 may comprise one or more light-injection elements 102.1. For example, it comprises between three and ten light-injection elements 102.1. In the example of FIG. 1b, the device 100 comprises two groups 102 each of 8 light-injection elements 102.1.

It will be noted that, during the production process for producing the light guide 105, the light-injection elements 102.1 and the light guide sheet 110 are made from a large raw sheet which will be trimmed at one extremity in order to separate the different light-injection elements 102.1 along the axis Y illustrated in FIG. 1a or 1b, and thus form the different light-injection elements 102.1 and the light guide sheet 110. Thus the light-injection elements 102.1 remain attached to the light guide sheet 110 at one of their extremities. What is meant by trimming the raw sheet is cutting through all of the layers comprised in the raw sheet in order to form parallel strips constituting the light-injection elements 102.1.

FIG. 1c depicts a support element 500 for the folding of the light-injection elements 102. The support element 500 comprises a series of folding elements 504 which are aligned in the direction z illustrated in FIG. 1c. Each folding element 504 is associated with a light-injection element 102 so as to allow same to be folded along a fold 102.14 formed when this element 102 comes into contact with a folding edge 504.14 of the folding element 504.

As illustrated in FIG. 1d, each light-injection element 102.1 in a folded state is made up of:
a main part 102.12 which is cut from the light guide sheet and extends from the light guide sheet 110, and
an end part 102.13 which extends along the axis z.

The end part 102.13 is connected to the light guide sheet 110 by means of the main part 102.12. The main part 102.12 and the end part 102.13 are separated by a fold 102.14 at a folding element that is not depicted in FIG. 1d. The end part 102.13 extends after the fold 102.14. The fold 102.14 is a right-angled fold. FIG. 1d illustrates the end parts 102.13, the main parts 102.12 of light-injection elements 102.1 of a group 102, and the fold 102.14 separating them.

As illustrated in FIG. 1e, the light-injection elements 102.1 of a group 102 are folded such that their end parts 102.13 form a stack 123 with a thickness E adapted to suit an emission surface of the light source 20. The thickness E is the sum of the thicknesses e of each light-injection element 102.1, the end parts 102.13 of which form the stack 123. The stack 123 has an entry surface 123.1, which is formed by the extremities of the end parts 102.13 of each of the light-injection elements 102.1 of the group 102. This entry surface 123.1 forms a free end of the group of light-injection elements 102 concerned.

Thus, thanks to the folding-support element for folding the light-injection elements, the latter are folded in such a way that they can be superposed on one another to form a stack of which the cross section corresponds to the size of the light source.

The group of light-injection elements 102 is coupled with at least one light source 104. More specifically, the free end 123.1 of the group 102 is positioned facing the light source 104 so as to receive the light rays R emitted by said source in each of the light-injection elements.

Given that the light-injection elements are formed as one with the light guide sheet, the light rays R will travel by total internal reflection in the light-injection elements 102.1 of the group 102, so as to bring light to the light guide sheet 110, which is adjacent and attached to the light-injection elements 102.1, and which will thus illuminate the region or regions of the light guide sheet 110.

The technical solution known to those skilled in the art and illustrated in FIGS. 1a, 1b, 1c, 1d and 1e allows the light to be coupled to the guide sheet and relies on the cutting of the raw sheet to form the stacks of light-injection elements that can be coupled to the light sources positioned on a printed circuit.

When a light guide as described is used for a large area to be illuminated, it is often necessary to segment the surface of the guide sheet into multiple regions, each region being coupled to a different light source by means of a group of injection elements. This configuration is illustrated in FIG. 1b.

In order to obtain the configuration as presented, the folding-support element for the folding of the light-injection elements comprises two series of folding elements which are aligned, each of these series being associated with one group of light-injection elements. One series is positioned higher up than the other, this corresponding to the position of the groups of light-injection elements.

### SUMMARY OF THE INVENTION

The invention offers an alternative to the configuration presented previously to meet the need for illumination of different regions of the light guide sheet.

A first aspect of the invention relates to a light guide for a luminous device, comprising:
a flexible and transparent light guide sheet suitable for guiding light by total internal reflection and for allowing light to exit through an exit face in a first direction x;
at least two groups of light-injection elements suitable for coupling the light guide sheet to at least one light source; each group of light-injection elements injecting light into a different region of said light guide sheet;
said light guide sheet and said at least two groups of light-injection elements forming part of a raw sheet; the light-injection elements being parallel strips cut from said raw sheet, said light-injection elements being folded and grouped together to form said at least two groups of light-injection elements.

According to the invention, the light guide comprises a folding-support element supporting the folding of the light-injection elements. This support element:
has a thickness in the first direction x and a length in a second direction z, the second direction z being substantially perpendicular to the first direction x;
comprises at least two series of folding elements extending in the second direction z, each series being associated with a different group of light-injection elements, each light-injection element being in contact with a folding element; and said at least two series of folding elements being offset in the first direction x.

Furthermore, said at least two groups of light-injection elements are offset in the first direction x.

The light guide according to the first aspect of the invention makes it possible to produce a luminous device having multiple luminous regions. Thanks to the use of multiple groups of light-injection elements, it is possible to effectively illuminate each region of the light guide while at the same time limiting the bulkiness of the device.

The raw sheet has the same physical and optical characteristics as the light guide sheet and the light-injection elements. In particular, the raw sheet is transparent and flexible and allows the light rays to travel within it via total internal reflection.

According to one embodiment of the light guide, contact between each light-injection element and the folding element associated with it forms a fold in said light-injection element so as to divide this element into a main part and an end part. For example, the end parts of the light-injection elements belonging to one and the same group may be superposed to form a stack. The ends of the stacks are positioned facing a light source so as to collect the light emitted by the source. The light rays are guided by the light-injection elements as far as the region of the sheet that is associated with each group of light-injection elements.

According to one embodiment, what is meant by the fact that two groups of light-injection elements are offset in the direction x is that the ends of the stacks of corresponding light-injection elements are offset.

By virtue of the folding-support element that supports the folding of the light-injection elements, the light guide according to the first aspect of the invention allows effective segmentation of the light guide sheet while at the same time limiting the dimensions of the display device and particularly of the light sources support.

What is meant by a light-injection element is a suitably cut part of the raw sheet. According to one embodiment, each light-injection element has the form of a rectangular strip extending from the raw sheet. The light-injection element thus obtained is a waveguide able to couple the light to the flexible and transparent guide sheet so as to illuminate a collection of light-extraction elements arranged at the surface of the film or of one of the layers of the light guide sheet.

The folding-support element allows each light-injection element to be folded at a folding element with which the light-injection element is in contact. Once folded, the light-injection elements associated with one and the same region of the light guide sheet form a stack, as described in connection with the figures illustrating the prior art. The stack thus obtained has a cross section, on a plane of section normal to the direction of travel of the light, of a size suited to being coupled to one of the light sources.

By virtue of the fact that the series of folding elements are offset in the first direction x, the stacks associated with different groups of waveguides are themselves also offset in that same direction.

In other words, the folding-support element of the waveguide according to the first aspect of the invention enables the stacks corresponding to the various groups of waveguides to be positioned in two or more rows, the rows themselves also being offset in the first direction x.

Positioning the stacks in two or more rows enables the use of a two-dimensional matrix of light sources.

In other words, by virtue of the structure of the folding-support element comprised in the light guide according to the first aspect of the invention, it is possible to reduce the size of the light sources support. In particular, the resulting y-direction extent of the light sources support is greatly reduced by virtue of the coupling element according to the first aspect of the invention.

Advantageously, the light guide according to the first aspect of the invention comprises a separation element arranged between said at least two groups of light-injection elements.

Advantageously, the separation element is opaque so as to prevent light from passing between said at least two groups of light-injection elements.

Advantageously, the folding elements have the shape of a right-angled isosceles triangle. This enables each light-injection element to be folded at a right angle.

Advantageously, each light-injection element comprises a main part extending from the raw sheet and an end part, the end part and the main part being separated by a fold at a folding element of the folding-support element that supports the folding of the light-injection elements.

Advantageously, the end parts belonging to one and the same group of light-injection elements are superposed to form a stack, the stacks belonging to different groups of light-injection elements being offset in the first direction x.

Advantageously, each stack of light-injection elements has one end facing a light source.

Advantageously, each triangular folding element has one side in contact with a light-extraction element, said side being in contact with a light-extraction element having a length of between 1 mm and 10 mm; this arrangement enables each waveguide to be folded to direct it toward the light sources. The length of the side in contact with the light-extraction element is greater than or equal to the width of each element.

A second aspect of the invention relates to a luminous device comprising a plurality of light sources.

According to the invention, the luminous device comprises a light guide according to the invention. Moreover, each of said at least two groups of light-injection elements comprises an end positioned facing at least one light source so as to receive light coming from said at least one light source. Thus, the luminous device comprises at least two luminous regions that can be illuminated independently while at the same time being compact, lightweight and easily adaptable to suit any installation surface area. The luminous device proposed allows these two regions to be lit alternatively or together, this being particularly well-suited to luminous animations proposed for example on an automotive vehicle.

Advantageously, each of said at least two groups of light-injection elements is associated with at least one different light source. In this case, the light sources are themselves likewise offset in the first direction x.

Advantageously, the at least two groups of light-injection elements which are offset in the first direction x are configured in such a way that the ends of said at least two groups of light-injection elements are aligned in the second direction z. This arrangement enables all the light sources to be positioned on one and the same support.

Advantageously, the at least two groups of light-injection elements which are offset in the first direction x are configured in such a way that the ends of said at least two groups of light-injection elements are offset in the second direction z.

Advantageously, the light sources positioned facing said at least two groups of light-injection elements have the same characteristics.

Advantageously, the light sources positioned facing said at least two groups of light-injection elements have different characteristics.

Advantageously, the luminous device according to the second aspect of the invention comprises a separation element arranged between the light sources arranged facing said at least two groups of light-injection elements.

A third aspect of the invention relates to an automotive vehicle comprising a luminous device according to the second aspect of the invention.

### BRIEF DESCRIPTION OF THE DRAWINGS

The figures are presented by way of indication and in no way limit the invention:

FIG. 1a illustrates a view in cross section of a light guide sheet used for a light guide according to the prior art;

FIG. 1b illustrates a display device comprising a light guide according to the prior art;

FIG. 1c schematically illustrates a light sources support according to the prior art;

FIG. 1d illustrates the folding of a group of light-injection elements associated with a region of the light guide sheet of the device according to FIG. 1b;

FIG. 1e illustrates one end of a stack of light-injection elements, which end is intended to be coupled to a light source;

FIG. 2a illustrates the folding-support element supporting the folding of the light-injection elements according to the first aspect of the invention;

FIG. 2b shows a view in an X-Y plane of the support element of FIG. 2a;

FIG. 3 schematically illustrates how the light-injection elements are folded over at the folding elements of the folding-support element of FIG. 2a;

FIG. 4 and FIG. 5 illustrate the folds of the light-injection elements on two offset series of the folding element;

FIG. 6a illustrates a luminous device according to the second aspect of the invention;

FIG. 6b shows a view in the X-Y plane of the light sources support element;

FIG. 7a shows a separation element inserted between two adjacent stacks of light-injection elements;

FIG. 7b shows a separation element inserted between two parallel rows of light sources;

FIG. 8a illustrates a first embodiment of the luminous device according to the second aspect of the invention; and

FIG. 8b illustrates a second embodiment of the luminous device according to the second aspect of the invention.

### DETAILED DESCRIPTION OF THE INVENTION

The figures are presented by way of indication and in no way limit the invention.

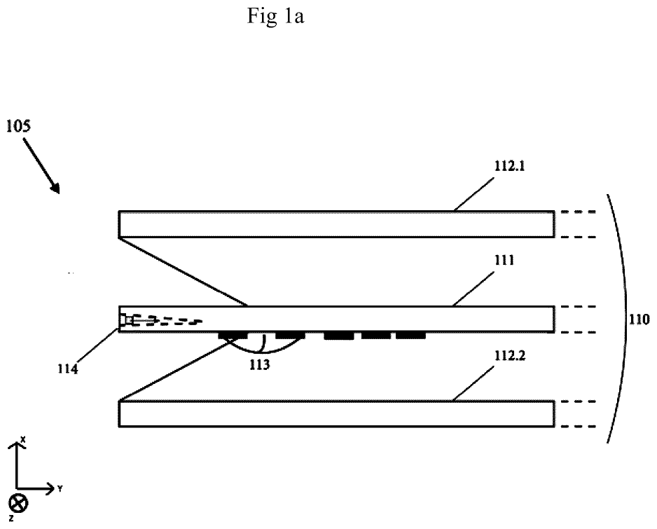

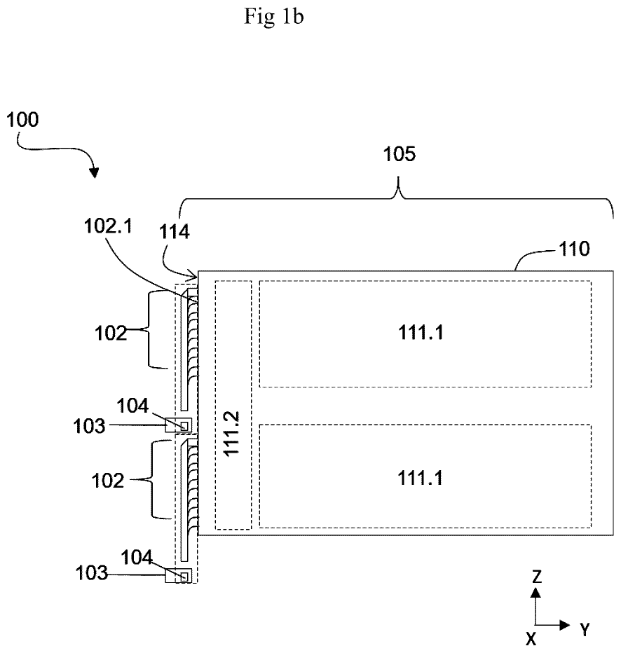

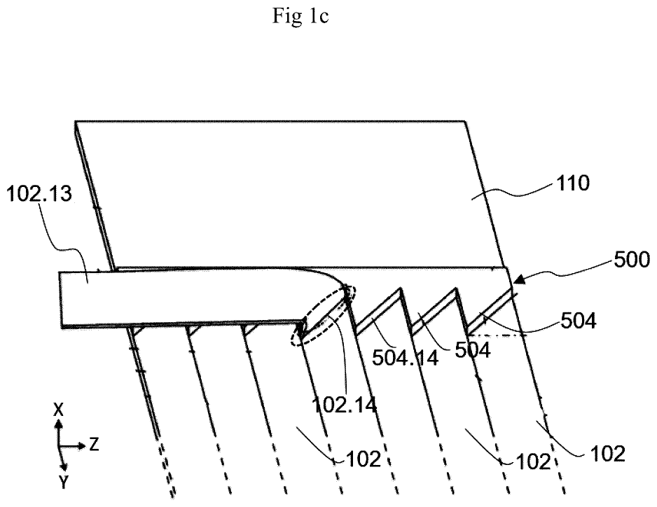

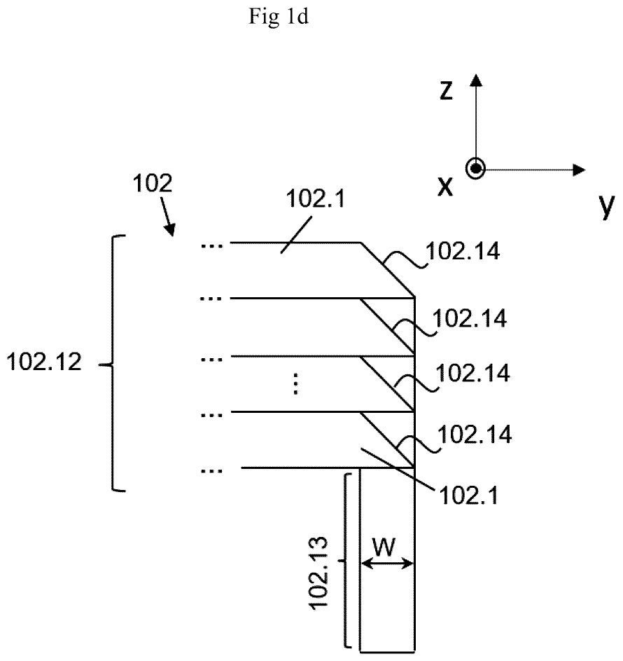

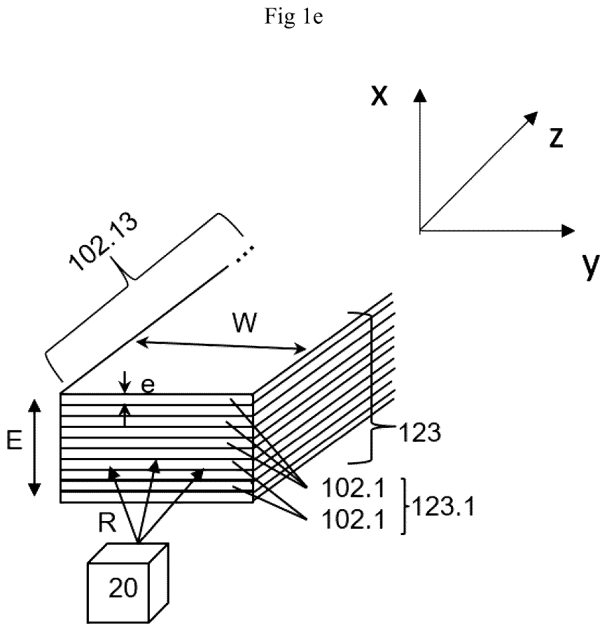

FIGS. 1a, 1b, 1c, 1d and le were described in connection with the prior art. In what follows, the orthonormal frame of reference defined by the first direction x, the second direction y and the third direction z will be used. This frame of reference is depicted in each figure.

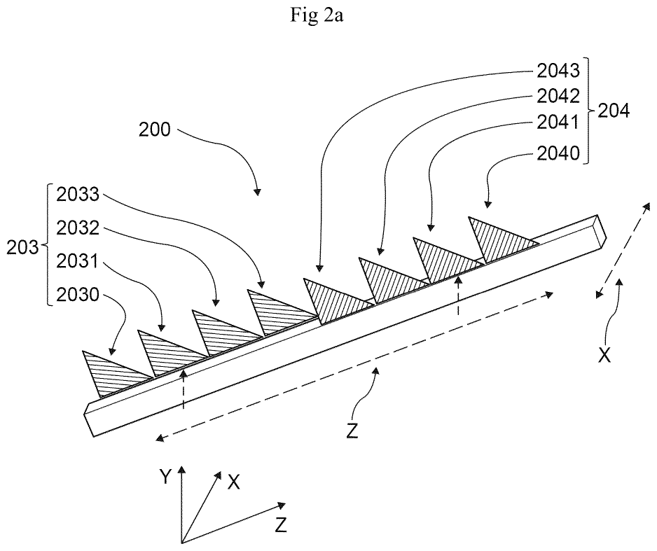

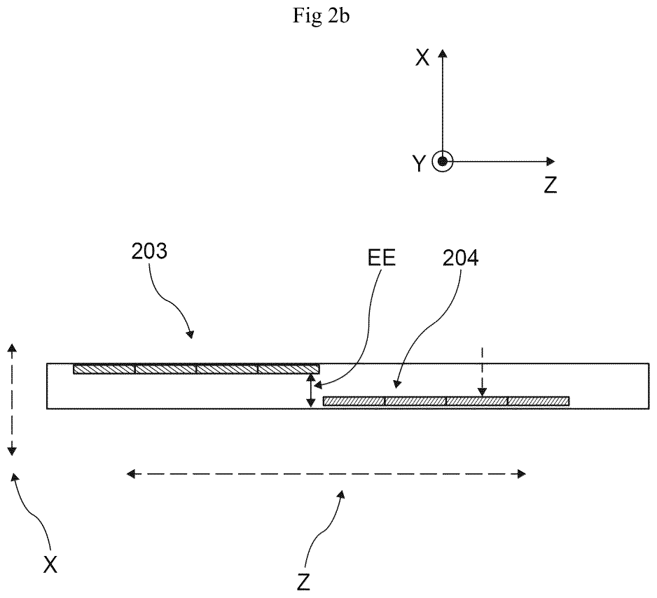

FIG. 2a shows a side view of the folding-support element 200 that supports the folding of the light-injection elements comprised in the light guide according to the first aspect of the invention. The element 200 extends in a first direction x and in a second direction z.

The element 200 comprises two series or rows 203 and 204 of folding elements. In the nonlimiting example of FIG. 2a, each row comprises four folding elements. The first series 203 comprises the folding elements 2030, 2031, 2032 and 2033. The second series 204 comprises the folding elements 2040, 2041, 2042 and 2043.

Each series extends in the second direction z. The two series 203 and 204 are offset in the second first x. Advantageously, the lateral offsetting of the series of folding elements allows greater segmentation of the light guide sheet without an excessive increase in the size of the device.

Moreover, the lateral offsetting, in the first direction x, of the series of folding elements 203, 204 makes it possible to reduce the bulkiness of the light sources support, as will be explained in detail during the description of the luminous device according to the second aspect of the invention.

FIG. 2b illustrates a view along the axis z of the support element 200 illustrated in FIG. 2a. FIG. 2b shows that each series 203, 204 of folding elements extends in the direction z. The two series are offset by a distance EE in the first direction x.

According to the embodiment illustrated in FIG. 2a, each folding element has the shape of a right-angled isosceles triangle with one straight side parallel to the axis z and one straight side parallel to the axis y, the right-angled triangle having a finite thickness in the direction x. The hypotenuse of each right-angled triangle is in contact with a light-injection element. In other words, each folding element is a triangular prism of which the triangular face is a right-angled isosceles triangle. The face of the prism that connects two opposite triangular faces is in contact with a light-injection element that is to be folded.

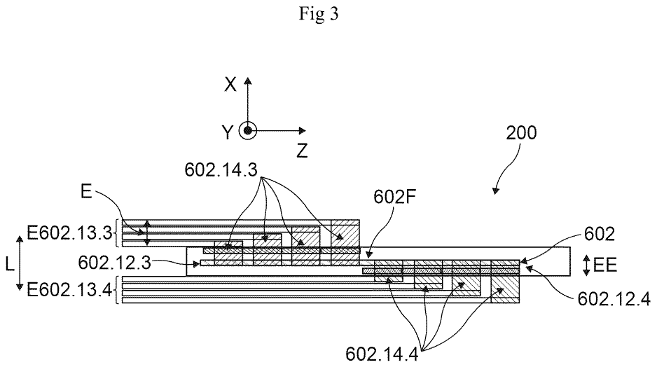

FIG. 3 illustrates how the element 200 comprised in the light guide according to the first aspect of the invention is used to fold over two groups of light-injection elements in such a way as to form two stacks E602.13.3 and E602.13.4 which are offset in the first direction x.

The two groups of light-injection elements each comprise main parts 602.12.3 and 602.12.4, the main parts being cut from a raw sheet. The main parts extend from the raw sheet in the direction y and are folded at the folds 602.14.3 and 602.14.4, on the folding elements 203 and 204 respectively. Each fold 602.14.3 and 602.14.4 corresponds to a folding element of the element 200 according to the first aspect of the invention.

As illustrated in FIG. 3, the main parts 602.12.3 and 602.12.4 pass inside a slot 602F in the support element 200. The slot 602F extends in the direction z and is positioned between the two series of folding elements 203, 204. The first group of light-injection elements 602.14.3 is folded in a first direction; the second group of light-injection elements 602.14.4 is folded in a second direction. According to the example illustrated in FIG. 3, the first direction is the direction +x and the second direction is the direction-x.

The two groups of light-injection elements each comprise end parts forming the two stacks E602.13.3 and E602.13.4. The thickness E of each stack in the direction x is given by the product of the thickness e of each light-injection element and the number of elements stacked, as was described in connection with the prior art.

Advantageously, the stacks E602.13.3 and E602.13.4 each comprise the light-injection elements associated with two distinct regions of the light guide sheet. This enables these two regions to be illuminated independently, for example by coupling each stack with a different light source.

Advantageously, the two stacks E602.13.3 and E602.13.4 are offset in the first direction x by a distance L. That enables the two stacks to be coupled to two light sources that are themselves likewise offset in the first direction x, thereby making it possible to reduce the size of the light sources support.

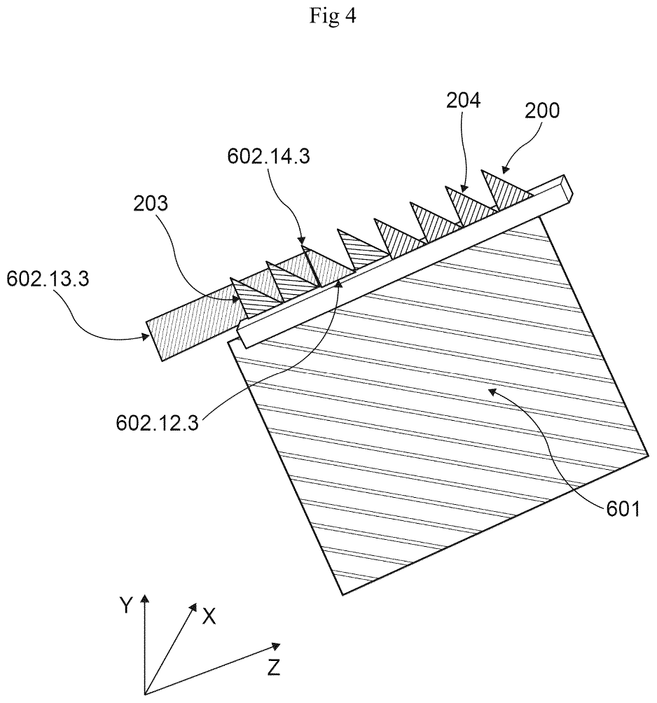

FIG. 4 illustrates a perspective view of the folding-support element 200 comprised in the light guide according to the first aspect of the invention and the folding of a light-injection element at a folding element of the row 203. The waveguide comprises a main part 602.12.3 cut into the raw sheet and an end part 602.13.3 extending in the second direction z. The fold 602.14.3 of the waveguide is formed at one of the triangular folding elements of the row 203.

FIG. 5 illustrates a perspective view of the folding-support element 200 comprised in the light guide according to the first aspect of the invention and the folding of a light-injection element at a folding element of the series 204 which is offset in the first direction x from the series 203. The light-injection element comprises a main part 602.12.4 cut into the raw sheet and an end part 602.13.4 extending along the axis z. The fold 602.14.4 of the waveguide is formed at one of the triangular folding elements of the series 204.

It is important to note that, by virtue of the folding-support element 200 comprised in the light guide according to the first aspect of the invention, the end parts 602.13.3 and 602.13.4 are offset in the first direction x.

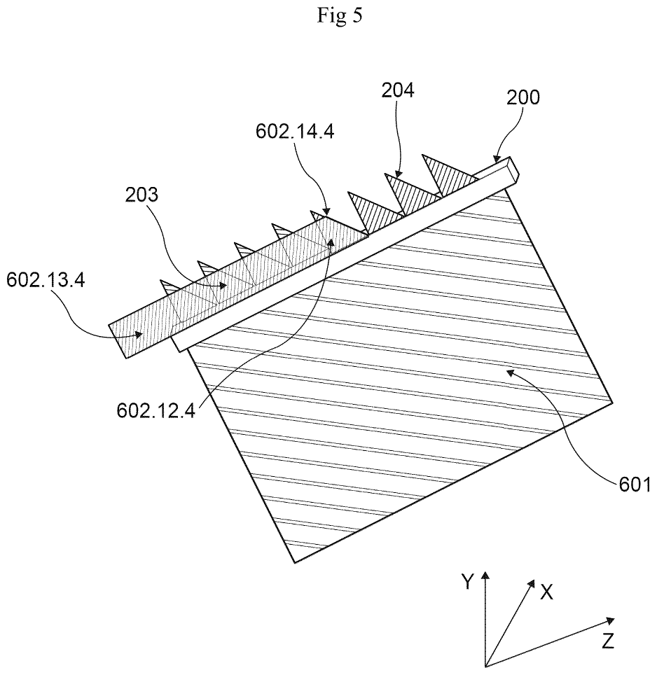

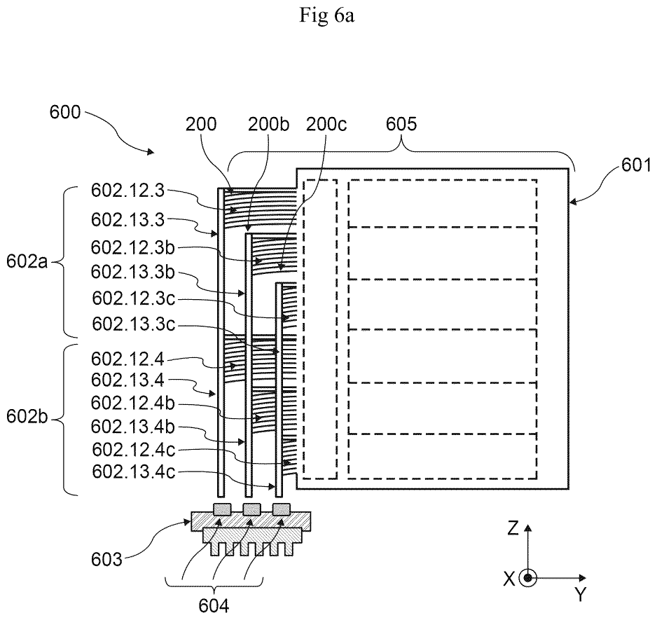

FIG. 6a illustrates a luminous device 600 according to the second aspect of the invention. The device 600 comprises:
one exemplary embodiment of a light guide according to the first aspect of the invention;
a support 603 comprising a plurality of light sources 604.

The light guide according to the first aspect of the invention comprises:
a light guide sheet 601 comprising a flexible film;
six groups of light-injection elements, three groups 602a and three groups 602b, each group of injection elements being associated with one region of the guide sheet 601.

The light guide further comprises three folding-support elements 200, 200b, 200c supporting the folding of the light-injection elements. Each folding-support element is associated with two groups of folding elements which are offset in the first direction x.

In the three groups 602a, each light-injection element comprises a main part 602.12.3, 602.12.3b, 602.12.3c. For the sake of clarity, only one light-injection element of each group 602a and 602b is referenced in FIG. 6a. Each group of light-injection elements 602a comprises the corresponding end parts 602.13.3, 602.13.3b, 602.13.3c.

The light-injection elements of the three groups 602b comprise a main part 602.12.4, 602.12.4b, 602.12.4c. Each group of light-injection elements 602b comprises the end parts 602.13.4, 602.13.4b, 602.13.4c.

The main parts 602.12.3 and 602.12.4 are in contact with the same folding-support element 200 and folded to form the corresponding end parts 602.13.3 and 602.13.4. The way in which the folding-support element 200 works was explained in connection with FIGS. 2a, 2b, 3, 4 and 5. The stacks E 602.13.3 and E 602.13.4 of light-injection elements comprising the end parts 602.13.3 and 602.13.4 are therefore offset in the first direction x. The same description applies to the other pairs of groups of light-injection elements, namely the pair (602.12.3b; 602.12.4b) which is associated with the folding-support element 200b and the pair (602.12.3c, 602.12.4c) which is associated with the folding-support element 200c.

In total, the luminous device 600 illustrated in FIG. 6a comprises six groups of light-injection elements, each group forming a stack. In the nonlimiting example illustrated in FIG. 6a, each stack has one end facing a light source 604 situated on the support 603.

The flexible and transparent light guide sheet 601 comprises a transparent film. The transparent film may be a polycarbonate (PC), polymethyl methacrylate (PMMA), thermoplastic polyurethane (TPU), or polyethylene terephthalate (PET) substrate film. The flexible film may have a thickness, that is a dimension in the first direction x, of between 12 and 1000 micrometers. More specifically, the thickness of the flexible film can range between 50 and 1000 micrometers, for example between 200 and 500 micrometers. As a variant, it is the thickness of the flexible guide sheet 601 comprising the flexible film that ranges between 200 and 1000 micrometers.

The aforementioned materials, combined with a low thickness as described above, allow a flexible and transparent light guide to be obtained. Other materials can be envisioned for the composition of the light guide sheet 601. However, it is preferable, according to the invention, to envision materials that are deformable and transparent.

According to one embodiment, the support 603 is a printed circuit.

Advantageously, as illustrated in FIG. 6b, the light sources are arranged in two parallel rows 604.4 and 604.3, the rows being offset in the first direction x. The offset between the two rows is identical to the offset between two stacks of light-injection elements.

In other words, the use of folding-support elements according to the first aspect of the invention enables the light sources 604 to be arranged in a two-dimensional matrix. That makes it possible to reduce the size of the support 604 and therefore the bulkiness of the luminous device 600 according to the second aspect of the invention.

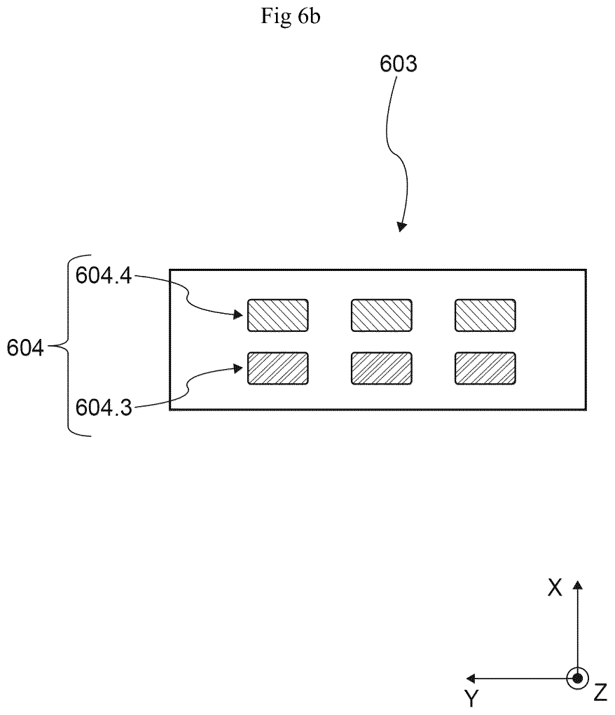

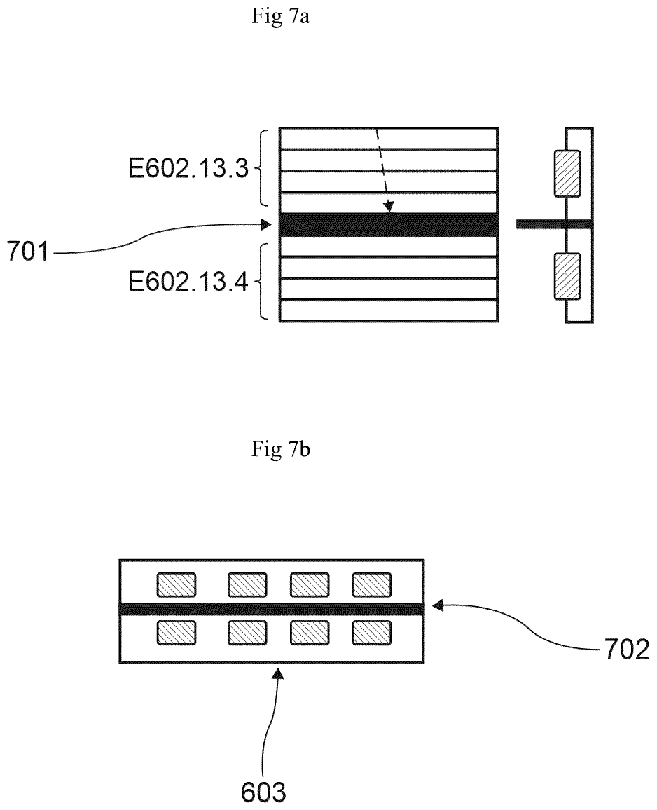

FIG. 7a illustrates a separation element 701 separating two stacks E602.13.3 and E E602.13.4.

Advantageously, the separation element 701 enables one stack to be isolated from the other to prevent light from being able to spread from one stack to the other.

According to one particularly advantageous embodiment, the separation element 701 is opaque, thereby preventing light from passing from one stack to the other.

According to the embodiment illustrated in FIG. 7b, the light sources support 603 comprises a separation element 702 separating the light sources.

Advantageously, the element 702 makes it possible to improve the sharpness of the images displayed on the flexible screen by preventing light emitted by one row of light sources from becoming coupled with the stacks facing a different row.

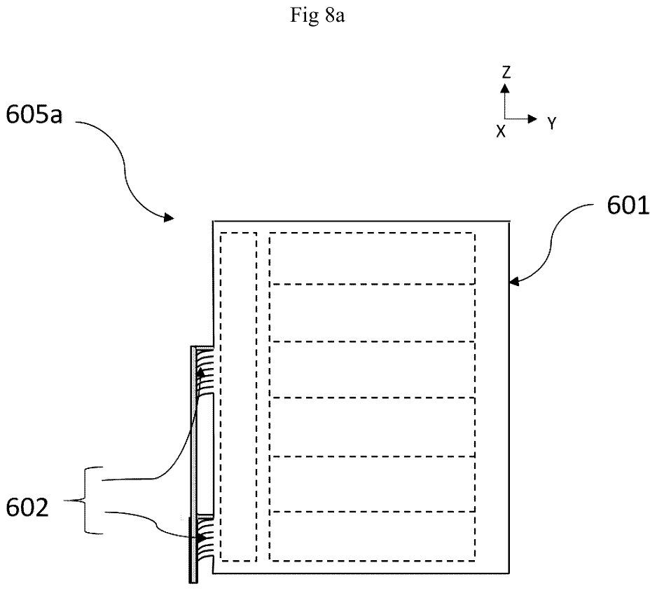

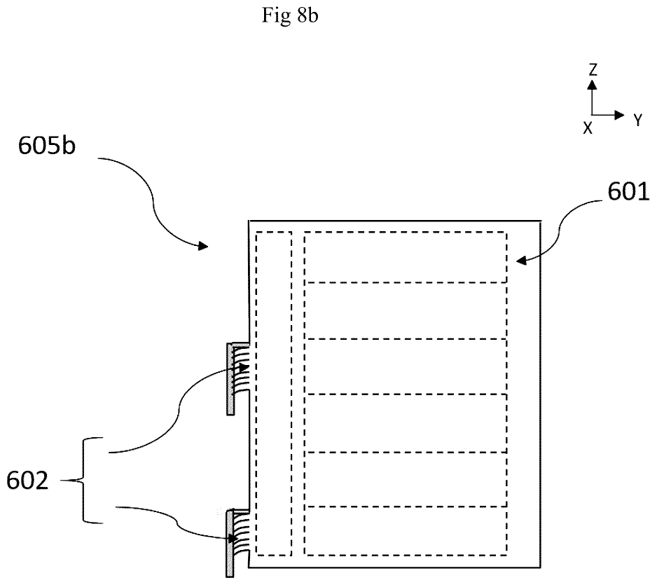

FIG. 8a illustrates one embodiment 605a of the light guide according to the first aspect of the invention. In this example, only two groups of light-injection elements 602 are illustrated. The stacks of light-injection element associated with the two groups 602 have different lengths from one another. As a result, the ends of the stacks are offset in the first direction x but aligned in the second direction z and the third direction y.

FIG. 8b illustrates another embodiment 605b of the light guide according to the first aspect of the invention. Likewise, only two groups of light-injection elements 602 are illustrated in FIG. 8b. In this example, the stacks of light-injection elements associated with the two groups of light-injection elements have the same length. As a result, the ends of the stacks are offset in the first direction x and in the second direction z.

What is claimed is:

1. A light guide, for a luminous device, comprising:
a flexible and transparent light guide sheet suitable for guiding light by total internal reflection and for allowing light to exit through an exit face in a first direction;
at least two groups of light-injection elements suitable for coupling a light guide sheet to at least one light source; each group of light-injection elements injecting light into a different region of the light guide sheet;
the light guide sheet and the at least two groups of light-injection elements forming part of a raw sheet; the light-injection elements being parallel strips cut from the raw sheet, the light-injection elements being folded and grouped together to form the at least two groups of light-injection elements;
support element for the folding of the light-injection elements, the support element:
having a thickness in the first direction and a length in a second direction, the second direction being substantially perpendicular to the first direction;
including at least two series of folding elements extending in the second direction, each series being associated with a different group of light-injection elements, each light-injection element being in contact with a folding element; and the at least two series of folding elements being offset in the first direction;
the at least two groups of light-injection elements are offset in the first direction.

2. The light guide as claimed in claim 1, further comprising a separation element arranged between the at least two groups of light-injection elements.

3. The light guide as claimed in claim 2, wherein the separation element is opaque so as to prevent light from passing between the at least two groups of light-injection elements.

4. The light guide as claimed in claim 1, wherein the folding elements have the shape of a right-angled isosceles triangle.

5. The light guide as claimed in claim 1, wherein the at least two groups of light-injection elements which are offset in the first direction are configured in such a way that the ends of the at least two groups of light-injection elements are aligned in the second direction.

6. The light guide as claimed in claim 1, wherein the at least two groups of light-injection elements which are offset in the first direction are configured in such a way that the ends of the at least two groups of light-injection elements are offset in the second direction.

7. A luminous device comprising a plurality of light sources;
a light guide, with the light guide including a flexible and transparent light guide sheet suitable for guiding light by total internal reflection and for allowing light to exit through an exit face in a first direction, at least two groups of light-injection elements suitable for coupling a light guide sheet to at least one light source, each group of light-injection elements injecting light into a different region of the light guide sheet, the light guide sheet and the at least two groups of light-injection elements forming part of a raw sheet; the light-injection elements being parallel strips cut from the raw sheet, the light-injection elements being folded and grouped together to form the at least two groups of light-injection elements, a support element for the folding of the light-injection elements, the support element having a thickness in the first direction and a length in a second direction, the second direction being substantially perpendicular to the first direction and including at least two series of folding elements extending in the second direction, each series being associated with a different group of light-injection elements, each light-injection element being in contact with a folding element; and the at least two series of folding elements being offset in the first direction, the at least two groups of light-injection elements are offset in the first direction; and
each of the at least two groups of light-injection elements includes an end positioned facing at least one light source so as to receive light coming from the at least one light source.

8. The luminous device as claimed in claim 7, wherein each of the at least two groups of light-injection elements is associated with at least one different light source

9. The luminous device as claimed in claim 7, wherein the light sources positioned facing the at least two groups of light-injection elements have the same characteristics.

10. The luminous device as claimed in claim 7, wherein the light sources positioned facing the at least two groups of light-injection elements have different characteristics.

11. The luminous device as claimed in claim 7, further comprising a separation element arranged between the light sources arranged facing the at least two groups of light-injection elements.

12. An automotive vehicle comprising a luminous device, luminous device includes a plurality of light sources, a light guide, with the light guide including a flexible and transparent light guide sheet suitable for guiding light by total internal reflection and for allowing light to exit through an exit face in a first direction, at least two groups of light-injection elements suitable for coupling a light guide sheet to at least one light source, each group of light-injection elements injecting light into a different region of the light guide sheet, the light guide sheet and the at least two groups of light-injection elements forming part of a raw sheet; the light-injection elements being parallel strips cut from the raw sheet, the light-injection elements being folded and grouped together to form the at least two groups of light-injection elements, a support element for the folding of the light-injection elements, the support element having a thickness in the first direction and a length in a second direction, the second direction being substantially perpendicular to the first direction and including at least two series of folding elements extending in the second direction, each series being associated with a different group of light-injection elements, each light-injection element being in contact with a folding element; and the at least two series of folding elements being offset in the first direction, the at least two groups of light-injection elements are offset in the first direction, and each of the at least two groups of light-injection elements includes an end positioned facing at least one light source so as to receive light coming from the at least one light source.
